(19) United States
(12) Patent Application Publication
(10) Pub. No.: US 2008/0073448 A1
(43) Pub. Date: Mar. 27, 2008

(54) ANTI-STRINGING APPLICATOR

(75) Inventor: John Kirby Kendall, Cedar Park, TX (US)

Correspondence Address: JOHN KIRBY KENDALL, 1429 SPIDERLILY VIEW, CEDAR PARK, TX, 78613, US

(73) Assignee: John Kirby Kendall, Cedar Park, TX (US)

(21) Appl. No.: 11/858,389

(22) Filed: Sep. 20, 2007

Related U.S. Application Data
(60) Provisional application No. 60/826,901, filed on Sep. 25, 2006.
(60) Provisional application No. 60/887,340, filed on Jan. 30, 2007.

(51) Int. Cl. B05B 7/24

(52) U.S. Cl. 239/337

(57) ABSTRACT

Embodiments of the systems and methods disclosed here are generally directed to anti-stringing systems that can be used in the application of a substance to a work surface. In one embodiment, an anti-stringing system includes an applicator having a nozzle for applying a substance to a work surface and a gas port configured to deliver a gas flow that disrupts the flow of the substance. In some embodiments, the gas port is located at least partially internally of and coaxial with the nozzle such that the substance flowing from the nozzle envelops one end of the nozzle. In other embodiments, the invention concerns hand-held glue guns having anti-string systems. In yet other embodiments, methods for breaking substance strings are disclosed. One such method includes delivering a gas flow that is substantially coaxial with the direction of flow of the substance. Various inventive embodiments relate to methods and devices for delivering a gas flow to a gas port.

### REFERENCE TO RELATED APPLICATIONS

This application claims an invention which was disclosed in Provisional Application No. 60/826,901 entitled “ANTI-STRINGING APPLICATOR”, filed Sep. 25, 2006, and U.S. Provisional Application No. 60/887,340, entitled “ANTI-STRINGING APPLICATOR”, filed Jan. 30, 2007. The benefit under 35 USC §119(e) of the United States provisional applications are hereby claimed, and the aforementioned applications are hereby incorporated herein by reference.

### FIELD OF THE INVENTION

The invention relates generally to the application of a substance to a work surface, and more particularly, the invention concerns systems and methods for substantially reducing or eliminating the formation of strings after application of the substance to a work surface

### BACKGROUND OF THE INVENTION

Substances with high extensional viscosity are found in a range of technologies, from liquid polymers, such as adhesives and paints, to food products, such as molten cheese and egg-based products. Usually, an applicator is used to dispense such a substance onto a work surface (or into a receptacle). Typically, when the flow of one of these fluids is stopped or disrupted, the substance tends to stretch between the work surface and the applicator. In certain situations, unwanted threads (“stringing”) of substance form between the applicator and the work surface. Stringing is problematic in large and small industry, as well as in home use applications. Stringing of hot melt adhesives can be especially troublesome since the string cools as it forms and creates a solid string that lengthens and draws adhesive from both the applicator and the work surface.

Stringing is often differentiated from dripping or drooling. For example, hot melt adhesive is generally applied by using pressure to force the molten adhesive out of the nozzle of an applicator. To stop supplying adhesive, the pressure is removed; however, the residual adhesive in the nozzle may ooze out and drip where it is not desired. Several solutions to this problem are known.

Methods are known to prevent stringing of viscous liquids. Some methods rely on the formulation of the adhesive to provide adhesives with extensional viscosities favorable to the reduction of stringing. Other anti-stringing solutions involve mechanical approaches. For example, U.S. Pat. No. 4,430,147 provides an anti-stringing wheel in counter-rotation to an adhesive applicator wheel. However, such a device will not work with nozzle application of the viscous liquid. U.S. Pat. No. 5,773,095 teaches breaking the string by rapid movement of the applicator relative to the work surface. Such movement is impractical in many automated and manual situations, such in the use of hand-held applicators.

In some industries, such as in the manufacture of webbed polymers, liquid strings are desired. Air flow is used to generate the strings, to control where the strings form, and to cut the strings. By way of example, U.S. Pat. No. 5,145,689 describes the use of high velocity hot air to blow molten fibers from a die. Air plates are mounted on the tip of the die next to the polymer melt orifice. As the polymer melt exits the orifice, the converging air from the air plates forms strings. U.S. Pat. Nos. 6,158,628, 5,421,921, 5,683,036, and 5,685,911 teach the use of blasts of air adjacent to the nozzle or orifice to direct and/or cut the liquid strings. Using such air blasts to cut viscous liquid strings has drawbacks. Precise and expensive machining of the air passages is required. Additionally, the air channels widen the surface area of the applicator beyond the nominal size of the nozzle—making the applicator bulky and less able to fit in small areas.

Another method to prevent stringing and adhesive build-up on the applicator is provided in U.S. Pat. No. 4,375,275, which teaches an applicator for a viscous material, wherein a hollow spindle retracts inside the nozzle, the material flows around the spindle, and exits the nozzle. The spindle has an outside diameter that allows it to scrape clean the inside diameter surface of the nozzle when application is stopped. For the scraping purpose, the tolerance between the two surfaces is between 0.001 and 0.0005 inches. As the spindle scrapes clean the nozzle interior and reaches the nozzle end, a flow of air out the spindle removes the adhesive from the spindle end and nozzle tip. However, the hollow air spindle and nozzle are expensive to manufacture because of the tight tolerances required for effective scraping. Additionally, since there is no gap between the spindle and the nozzle, the spindle must be withdrawn deeply inside the nozzle to create a pathway for the adhesive to flow past the spindle tip and out of the nozzle. This extended linear motion of the spindle increases the overall length of the applicator, requires additional mechanical components, and requires greater energy to move the spindle.

More specifically, in the context of small industry or home use of hot melt glue guns, stringing can detract from the quality of a project. A known solution is to try to break the string by quickly snapping the wrist and the glue gun; however, in practice this method is effective only sometimes. There is currently a need for viable solutions to prevent stringing in the use of hot melt glue guns.

### SUMMARY OF THE INVENTION

The systems and methods illustrated and described herein have several features, no single one of which is solely responsible for its desirable attributes. Without limiting the scope as expressed by the description that follows, its more prominent features will now be discussed briefly. After considering this discussion, and particularly after reading the section entitled “Detailed Description of the Preferred Embodiments” one will understand how the features of the system and methods provide several advantages over traditional systems and methods.

In one aspect, the invention relates to a method of facilitating the disruption of strings formed by the application of a substance to a work surface. The method includes providing a nozzle for delivering the substance to the work surface, providing a gas port configured to deliver a gas flow, and positioning the gas port relative to the nozzle such that the substance flowing from the nozzle envelopes at least a portion of the gas port, and such that the gas flow from the gas port can disrupt the flow of the substance.

In yet another aspect, the invention to relates to anti-stringing systems. In one embodiment, an applicator for applying a substance to a work surface includes a nozzle adapted to deliver the substance to the work surface and a gas port configured to be enveloped by the substance and to deliver a gas flow to disrupt a flow of the substance. In some embodiments, the gas port is coaxial with the nozzle. In other embodiments, the gas port is located at least partly internal to the nozzle. For certain applications, the gas port is adjacent to the nozzle and configured to deliver the gas flow in a direction that is coaxial with the flow of the substance from the nozzle. In yet other embodiments, the gas port has a gas port outer surface that is smaller than an inner nozzle surface such that a space between the gas port outer surface and the inner nozzle surface is the flow path for the substance. In one embodiment, the applicator comprises a hot melt adhesive gun.

In one embodiment, the invention relates to detachable nozzles and corresponding substance applicators, wherein the nozzle and the applicator are adapted to receive one or more gas ports. In yet another embodiment, the invention is directed to substance applicators that include a gas port and a manual device for delivering a gas flow to the gas port. In one embodiment, the invention comprises a bulb configured to provide a gas flow to the gas port. In another embodiment, the invention concerns a piston body and a plunger configured to deliver a gas flow to the gas port. In yet other embodiments, various automatic, powered, or manual devices can be used to deliver a gas flow to the gas port.

### BRIEF DESCRIPTION OF THE DRAWING

FIG. 1 is a cross-sectional view of a nozzle and a gas tube in a first state.

FIG. 2 is a cross-sectional view the nozzle and gas tube of FIG. 1 in a second state.

FIG. 3 is a cross-sectional view of the nozzle and gas tube of FIG. 1 in a third state.

FIG. 4 is a cross-sectional view of another embodiment of a nozzle and a gas tube.

FIG. 5 is a front view of a nozzle and gas port.

FIG. 6 is a front view of another embodiment of a nozzle and gas port.

FIG. 7 is a front view of yet another embodiment of nozzle and gas port.

FIG. 8 is a schematic, cross-sectional view of a hand-held embodiment of an anti-stringing, hand-held, glue gun.

FIG. 9 is a schematic, cross-sectional view of another embodiment of an anti-stringing, hand-held, glue gun.

FIG. 10 is a cross-sectional view of a nozzle, gas tube, and ball/spring valve.

FIG. 11 is a cross-sectional view of a threaded nozzle and gas tube.

FIG. 12 is a cross-sectional view of a threaded nozzle and coupled gas tube.

FIG. 13 is a cross-sectional view of another threaded nozzle and coupled gas tube.

FIG. 14 is a top view of a threaded, multi-port nozzle and multiple gas tubes.

FIG. 15 is a cross-sectional view of the nozzle and gas tubes of FIG. 14.

FIG. 16 is a cross-sectional view of another embodiment of a nozzle and gas tube.

FIG. 17 is a schematic, cross-sectional view of another embodiment of an anti-stringing, hand-held, glue gun.

FIG. 18 is a schematic, cross-sectional view of another embodiment of an anti-stringing, hand-held, glue gun.

FIG. 19 is a schematic, cross-sectional view of another embodiment of an anti-stringing, hand-held, glue gun.

FIG. 20 is a schematic, cross-sectional view of another embodiment of an anti-stringing, hand-held, glue gun.

### DETAILED DESCRIPTION OF THE PREFERRED EMBODIMENTS

The inventive embodiments of the systems and methods disclose here are not limited to the application of particular polymers, formulation, liquid, product, or application temperatures. As used here a “substance”, at the temperature of application or dispensing, tends to form strings when flow of the substance is stopped temporarily or permanently. For example, inventive embodiments of the applicators disclosed here can be used equally well for dispensing honey at ambient temperatures or applying hot melt glue at elevated temperatures.

In one embodiment, the invention relates to a substance applicator configured to disrupt the flow of a substance by the flow of a gas out of a gas port. In some embodiments, the gas port is located between a nozzle of the applicator and the work surface. In one embodiment, the gas port can be located permanently in front of the nozzle. The gas port can be adapted to be enveloped by the substance (that is, the substance flows around the gas port) to disrupt flow of the substance.

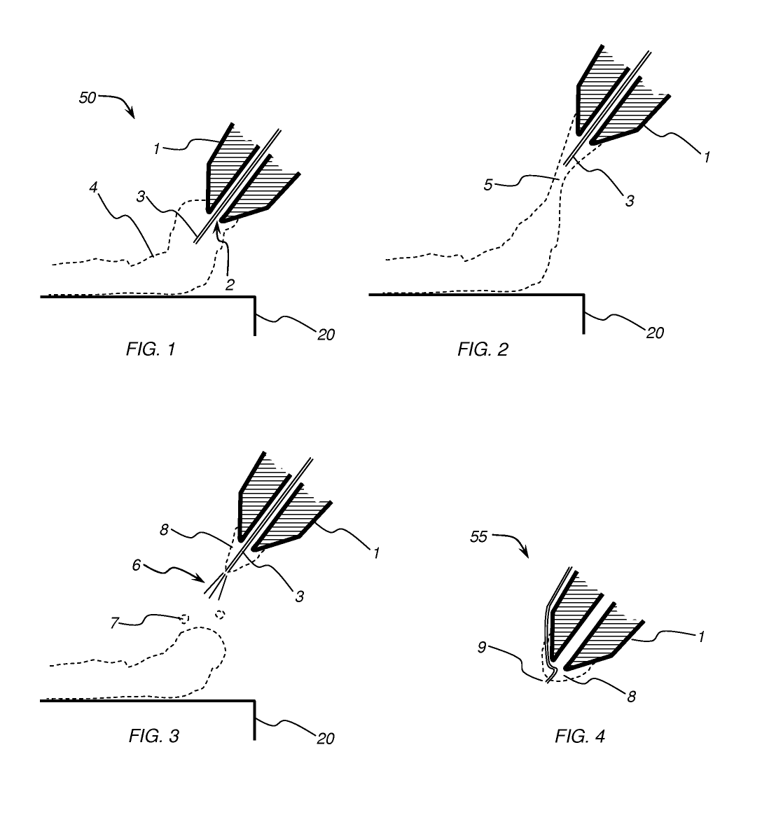

FIGS. 1-3 illustrate a system 50 that prevents, or substantially reduces, stringing. Referring to FIG. 1, the system 50 can include a nozzle 1, having a nozzle orifice 2, that is adapted to supply a substance 4 to a work surface 20. The substance 4 flows around and envelops a gas port 3 that, in this embodiment, is located inside the nozzle orifice 2. Referring to FIG. 2 now, when the substance 4 stops flowing from the nozzle 1, and as the nozzle 1 moves away from the work surface 20, string precursor 5 begins to form. If no additional steps were taken at this point, string precursor 5 would lengthen undesirably as the work surface 20 and the nozzle 1 continue to separate.

As FIG. 3 shows, the gas port 3 can be configured to supply a gas flow 6 that disrupts or breaks string precursor 5. In some embodiments, in the process of breaking string precursor 5, small droplets 7 form and fall on the work surface 20. In some cases, a residual bead 8 of the substance 4 can remain on the tip of the nozzle 1. In some embodiments, the gas flow 6 can be caused by mechanical or electrical activation due to activity or movement on the working surface 20. Alternatively, the gas flow 6 can occur at regular intervals governed by a timer or automatic pressure release system, for example.

In one embodiment, the gas flow 6 breaks the flow of the substance 4. Preferably, the disruption occurs while the substance 4 is still flowing to the nozzle 1 and the working surface 20. The disruption can be momentary, and the flow of substance 4 to the working surface can resume quickly. The momentary disruption can be used for the dispensing of substances into containers on a moving conveyer belt, for example.

The velocity and/or volume of the gas flow 6 can be chosen to suit a given application. It should be noted that if the velocity of the gas flow 6, described in terms of the gas pressure before the outlet of the gas port 3, is too low, then the forming string 5 might not break at the gas port 3. In this situation, the flow of the substance 4 might be disturbed but not sufficiently disrupted. For example, it has been observed that a gas pressure of 5-pounds-per-square-inch (psi) in a prototype apparatus was not sufficiently high to break the string 5. Another test with the same prototype at 50 psi was suitable to prevent stringing. There is no theoretical upper limit on the pressure (and therefore flow rate) of the gas in the port tubing. The preferred upper and lower pressure limits will be determined by several factors including gas source, pressure drop in the tubing, material of construction, temperature, and viscous fluid properties.

In one embodiment, a low pressure steady gas flow 6 from the gas port 3 prevents accidental back-flow up, or plugging of, the gas port 3. Preferably, the gas flow 6 is not great enough to disrupt flow of the substance 4. However, when needed, the gas flow 6 can be increased and then the flow of the substance 4 can be disrupted. In some embodiments, the gas used to prevent string formation is heated, which can allow the use of lower gas pressure, gas flow-rate, and time. Otherwise, without heating, the gas flow 6 may actually cool the substance 4 at the tip of the gas port 3 and the gas may need to operate at a higher pressure or flow rate in order to disrupt the flow of the substance 4. The heat source for the gas can be internal or external to the applicator. It is preferred that in an applicator where the substance 4 is heated, as in a hot melt glue gun, that the substance heater and/or the heated substance 4 be used to heat the gas. This can be accomplished, for example, by having a gas chamber adjacent to the substance heater or by locating the gas flow tubing next to the heater or within the heated substance.

In some situations it can be desirable for the gas flow 6 to occur at regular intervals. This method is preferable in certain applications where, for example, a conveyer moves boxes past the applicator. The gas flow 6 can be configured to cause a disruption in the substance flow in the space between boxes. Alternatively, the gas flow 6 can be configured to activate only at the request of an operator. This situation can describe typical home use of a hot melt glue gun. The user may prefer for the gas flow 6 to occur as the glue flow is stopped and the gun is lifted away from the work surface, thus breaking any forming string 5.

In one embodiment, the gas flow 6 breaks string precursor 5 by passing out of the gas port 3. In some embodiments, the gas flow 6 can be air, nitrogen, carbon dioxide, halogenated hydrocarbons, freons, steam, or combustion gases, for example. The preferred gas is preferably suitable for use with any given gas dispenser or container. For example, where a compact, pressured gas cylinder is the preferred gas source, then widely available carbon dioxide cartridges are suitable. However, where the source of the gas is a battery operated piston, then ambient air can be a suitable gas. The mention of gases and gas sources is not exhaustive and should not be construed to limit the inventive systems and methods described here.

Some sources of gas can be adopted from widely-available commercial products. A spring-driven and/or motor-driven piston may compress the ambient air and be immediately forced out of the gas port 3. Examples of this type of gas source are the manually compressed and battery powered Airsoft® guns. A cylinder or cartridge of compressed air can be used to provide the gas to the gas port 3. An example is carbon dioxide powered BB guns. The combustion gases from the burning of fuel, instead of driving a piston, could exit out of the gas port 3. An example would be a modified internal combustion nail gun or internal combustion engine. Pressurized steam created by heating water in an enclosed environment, a modified steam engine for example, could exit the gas port 3. Air either compressed by a manually operated spring via a piston or by a hand pump could provide the gas flow 6. For example, a manual Airsoft® pistol or a Nerf® dart-type gun can provide the gas flow 6. Yet another source can be an air compressor to make the compressed air either immediately adjacent to, or within or remotely from the applicator, and providing the air via tubing. An example is an air compressor used to make the pressurized air for automobile air horns. The selected source of gas will preferably be suited to the applicator requirements. The gas source can vary and the examples above do not limit the scope of this application.

FIG. 4 illustrates the situation after a gas flow 6 from an anti-stringing system 55 has disrupted or broken string precursor 5 leaving the bead 8. In the embodiment illustrated, however, a gas port 9 is located externally of the nozzle 1. The gas port 9 can be positioned adjacent to the exterior of the nozzle 1, and configured to bend and end in front of the nozzle 1. The result is that the substance envelops the gas exit port 9, thus allowing the gas flow 6 to disrupt or break string precursor 5. The gas port 9 in some embodiments is configured to direct the gas flow 6 coaxially with the direction of substance flow from the nozzle 1.

The gas port 3 can have various configurations. When the nozzle 1 is linear, the gas port 3 can be formed in a linear fashion. In one embodiment, the substance 4 flows down both sides of the linear gas port 3, thus, enveloping the gas port 3. Alternatively, for the linear nozzle 1, the gas port 3 can be a series of ports (not shown) in close proximity. Preferably the ports are each enveloped by the flowing viscous liquid.

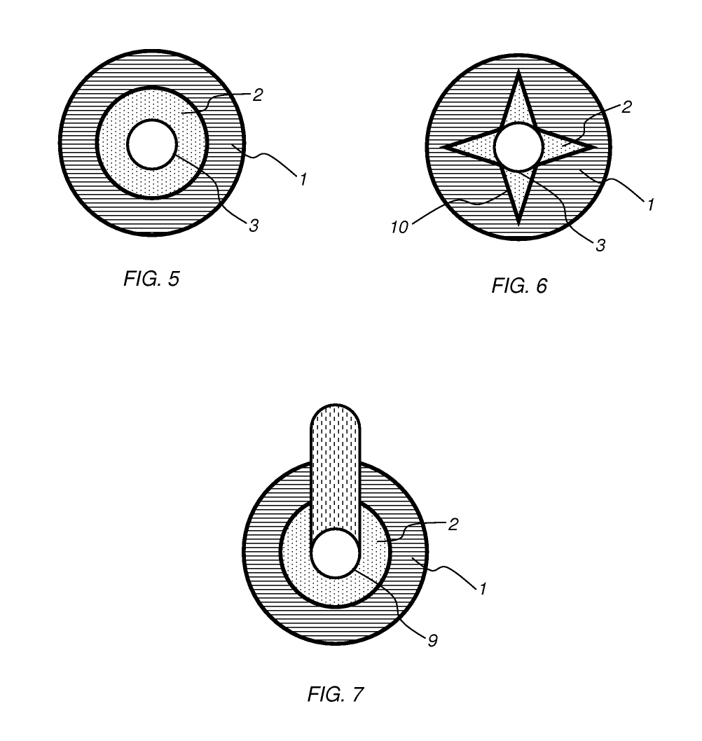

FIGS. 5-7 are front views of certain embodiments of nozzles for anti-stringing substance applicators. In FIG. 5, a gas exit port 3 is surrounded by a substance 2 as the gas exit port 3 exits from within the interior of a nozzle 1. In the embodiment of FIG. 6, the nozzle 1 has protrusions 10 that touch the gas port 3 and hold it in a preferred alignment. The substance 2 flows around the protrusions 10 to envelope the gas exit port 3. In the embodiment shown in FIG. 7, a gas port 9 is positioned proximate to the exterior of the nozzle 1. During use of the applicator, the liquid 2 envelopes the gas exit port 9. The variety of constructs of the nozzle shape and tubing path shown are not exhaustive and do not limit the scope of this application.

FIG. 8 illustrates one embodiment of a hand-held glue gun 80 that uses the anti-stringing system 50. The glue gun 80 can include a housing 14 that houses a gas source 11 coupled to the gas port 3. In one embodiment, a heating element 15 can be used to provide heat to the extension of the nozzle 1, and thus to the visvous fluid, and thus to the gas as it flows from source 11. A glue stick, or other similar substance, can be fed into an adhesive flow controller 13. It should be noted that certain components commonly found in hand-held glue guns are not shown. For example, a glue gun 80 can include switches, activators, or levers used for the gas or glue flow. The arrangement and inclusion of said components will be readily apparent to those of ordinary skill in the relevant technology.

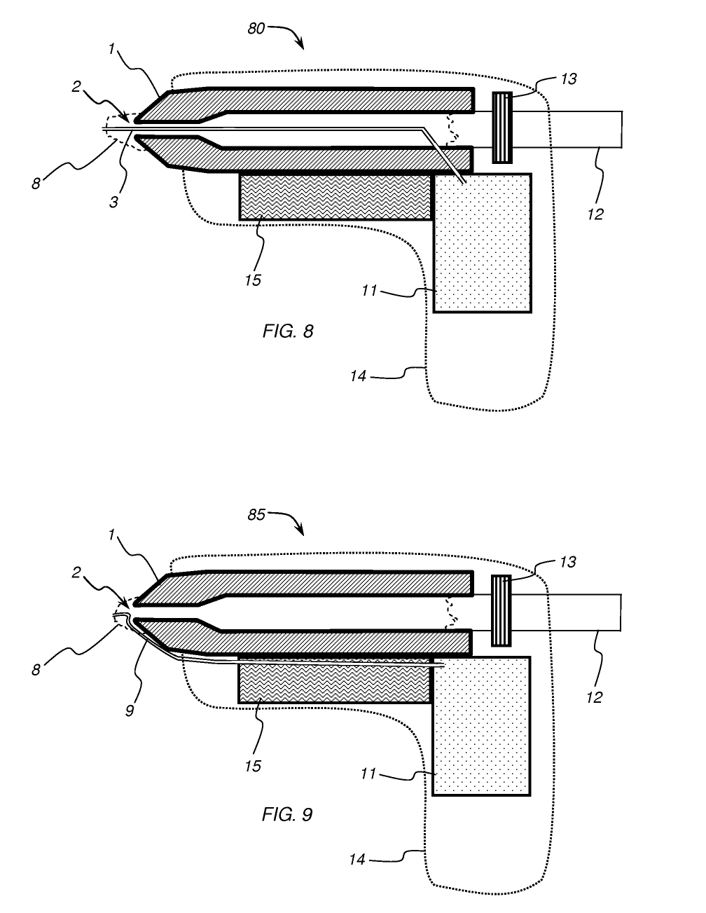

FIG. 9 illustrates yet another embodiment of a hand-held glue gun 85 that is substantially similar to the glue gun 80. However, the glue gun 85 implements the anti-stringing system 55, rather than the anti-stringing system 50. As shown, in one embodiment the glue gun 85 includes a gas port 9 that is coupled to the gas source 11 and is substantially adjacent and external to the nozzle 1. In one embodiment, the gas port 9 passes through, or is in contact with, the heating element 10. The gas port 9 can be configured to deliver a gas flow 6 that is substantially coaxial with the flow of the substance 4.

For hot melt glue guns 80, 85, for example, the disruption of the flow of glue occurs preferably after the application of the glue is stopped and the glue gun 80, 85 is being lifted away from the work surface 20. In this manner, any string precursor 5 between the nozzle 1 and the work surface 20 is broken. In some embodiments, a user can activate a manual switch or trigger (not shown) when lifting the glue gun 80, 85 away from the work surface 20. Alternatively, a level switch (not shown) within the gun 80, 85 can be configured to sense a change in the angle of the glue gun 80, 85 when the user lifts the gun 80, 85, thus automatically activating the gas flow 6 to the gas port 3.

In a common hand-held hot melt glue gun 80, 85, a nozzle 1 is a singular hole of about 1 to 5 millimeters in diameter. In some embodiments, for a hot melt glue gun 80, 85 for example, a preferred gas port 3 is tubing. When the gas port 3 is the terminus of a piece of tubing, then the inside and outside diameter of the tubing may be a variety of sizes. In one embodiment, the gas port 3 is tubing that terminates between 0.5 to 30 millimeters in front of the nozzle 1 (that is, in the direction of glue flow). In another embodiment, the tubing terminates between 2 to 15 millimeters in front of the nozzle 1. A preferred embodiment, in order to reduce the cost and complexity of the apparatus, is for the nozzle to reside at a fixed position that terminates in front of the nozzle; that is, the tubing does not retract or withdraw into the nozzle.

The material of the tubing for the gas port 3 is preferably selected to meet given design requirements. In some embodiments, a hot melt glue gun 80, 85 can use tubing made of a material that does not melt or unduly soften at the application temperatures. For such an application stainless steel tubing can be used. In other embodiments, a plastic material can be used for the tubing. For example, polytetrafluoroethylene is a plastic material that can be used with a typical hot melt glue gun. Lower manufacturing costs may dictate that yet another material be chosen for the tubing for the gas port 3.

As a general application, when tubing is the preferred method of delivering gas to the gas port 3, there are several possibilities to route the tubing to the space in front of the nozzle 1. When minimal or no modification to the nozzle 1 is preferred, the tubing can simply approach at an angle to the path of the substance 4 and into the space between the nozzle 1 and the work surface. For a similar but more compact configuration, the tubing can be positioned adjacent to the exterior of the nozzle 1. In some embodiments, the tubing can be located inside the nozzle 1 and the body of the applicator. For example, in a hot melt glue gun 80, 85, the tubing could enter the area of the melted glue anywhere from the side of the nozzle 1 itself to the entry point where the solid glue stick 12 enters the heater body. If there are anti-drip valves or other features in the nozzle 1 or melted glue area, these features can either be configured to fit around the tubing, or a groove can be cut into the interior body of the nozzle 1 or melted glue area, thus allowing the tubing to bypass the valve or other feature without negating interfering with its function.

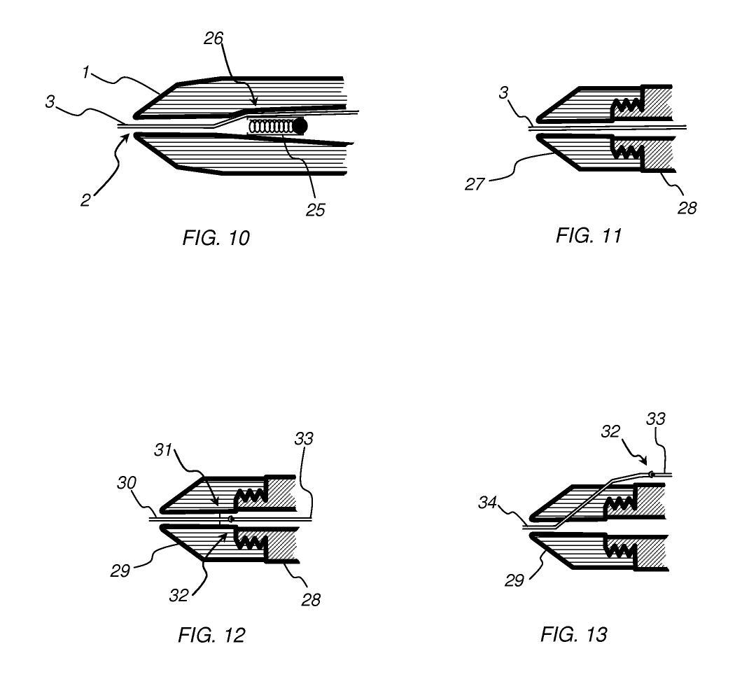

Referencing FIG. 10 now, in one embodiment the gas tube 3 can be configured to by-pass an anti-drool valve, for example. The nozzle 1 includes a groove 26 adapted to receive the gas tube 3. In one embodiment, the ball or spring valve assembly 25 makes a tight seal against the nozzle 1 and a portion of the gas tube 3. Hence, in this configuration, a greater length of tube 3 can be heated by the surrounding adhesive, in the instance of a hot melt glue gun.

As a general application, the exact type of valve used to activate the flow of gas is not limited by this application. A valve assembly can include solenoids, tubing pinch valves, ball valves, and spring seated valves, for example. Examples of the valves useful for this invention include those in aerosol spray cans, the ball valves in Super Soaker-type water guns, the valves in Nerf air guns, the valve and regulator in AirDr CO2 keyboard duster, and the valve and regulator in Visage Nail Art Airbrush. It may be preferred that a valve be “momentary”, that is, only providing a flow of gas while the valve is actuated, or only providing a short burst a gas flow regardless of how long the valve is actuated. Releasing the valve then allows for another flow of gas to occur on the next valve actuation.

Turning to FIG. 11 now, a detachable nozzle 22 is installed over a gas tube 3 that is fixed within the body of an applicator 28. For illustration, the nozzle 22 is provided with threads adapted to engage corresponding threads formed on the applicator 28; however, attachment of the nozzle 22 to the applicator 28 can be by any method known in the relevant technology.

As shown in FIG. 12, in one embodiment a gas tube coupling 32 can be provided. The gas tube 3 can include a removable end 30 that can be provided separately or integral with a nozzle 29. When the nozzle 29 is attached to the applicator 28, the removable end 30 attaches to a tubing portion 33, which can be received in and supported by the applicator 28. In other embodiments, there can be multiple and varied attachment points 31 for the removable end 30. The attachment points 31 ensure that the removable end 30 remains attached to the nozzle 29. In some embodiments, a flow of gas can be provided in the tubing portion 33 during a nozzle change operation. The gas can reduce or eliminate the possibility of accidentally getting applicator fluid into the removable end 30 or the tubing portion 33 during attachment of the nozzle 29. In one embodiment, as shown in FIG. 13, a gas port tube 34 can be adapted to pass through the body of the nozzle 29. The gas port tube 34 couples externally to a tubing portion 33 at a coupling junction 32. It should be noted that the exact manner of coupling the removable end 30 or the gas port tube 34 to the tubing portion 33 is not limited by the examples presented here. In some embodiments, such couplings can be made, in part, by snap couplings, threaded couplings, twist couplings, or pressure couplings, for example.

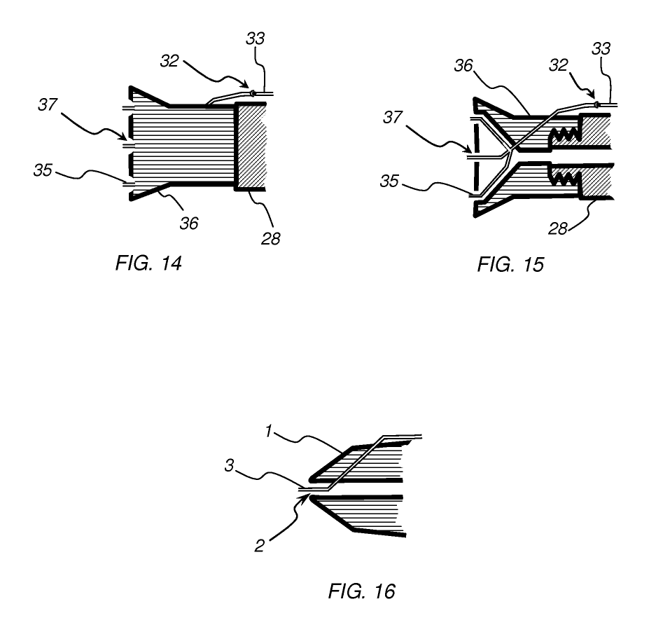

In some embodiments, the technology disclosed here can be used with multiport nozzles. FIG. 14 illustrates a nozzle 36 adapted with three fluid exit ports 37. As shown in FIG. 15, the nozzle 36 can have three gas ports 35, one for each fluid exit port 37. In one embodiment, the gas ports 35 can be coupled to a main gas line that connects to a tubing portion 33 at coupling junction 32. In some embodiments, the nozzle 36 can be provided with a greater or lesser number of fluid exit ports 37, each of which can be provided with its own gas port 35. It should be noted that the inventive embodiments of the anti-stringing technology are not limited to any specific nozzle 36. FIG. 16 shows yet another embodiment of a nozzle 1 and gas tube 3 configuration, in which the gas tube 3 is routed through the side wall of nozzle 1.

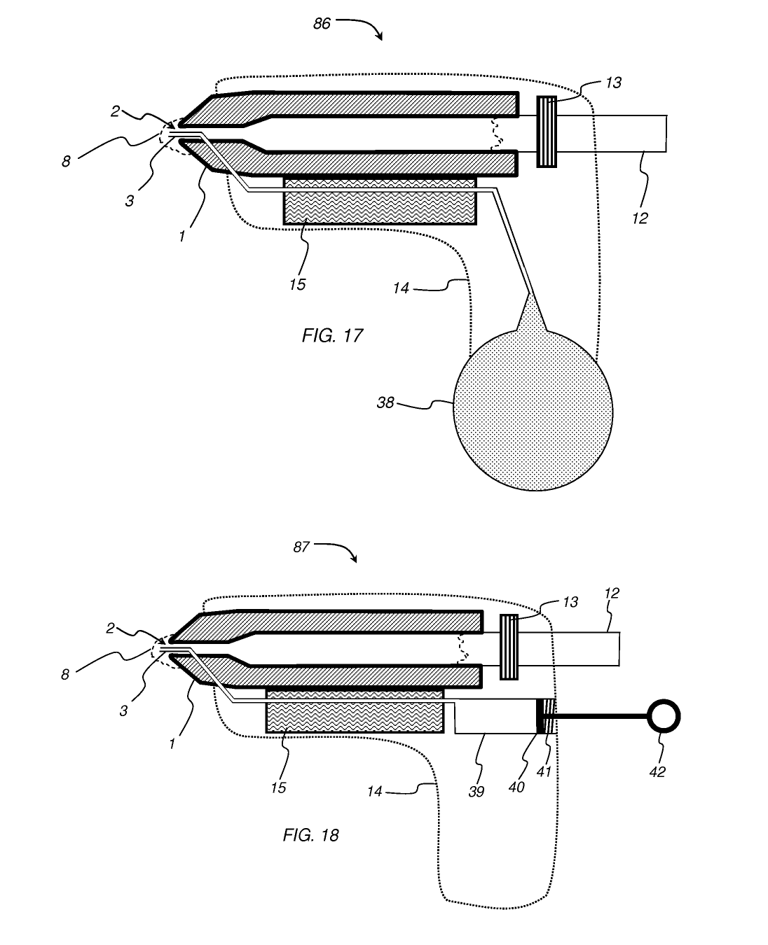

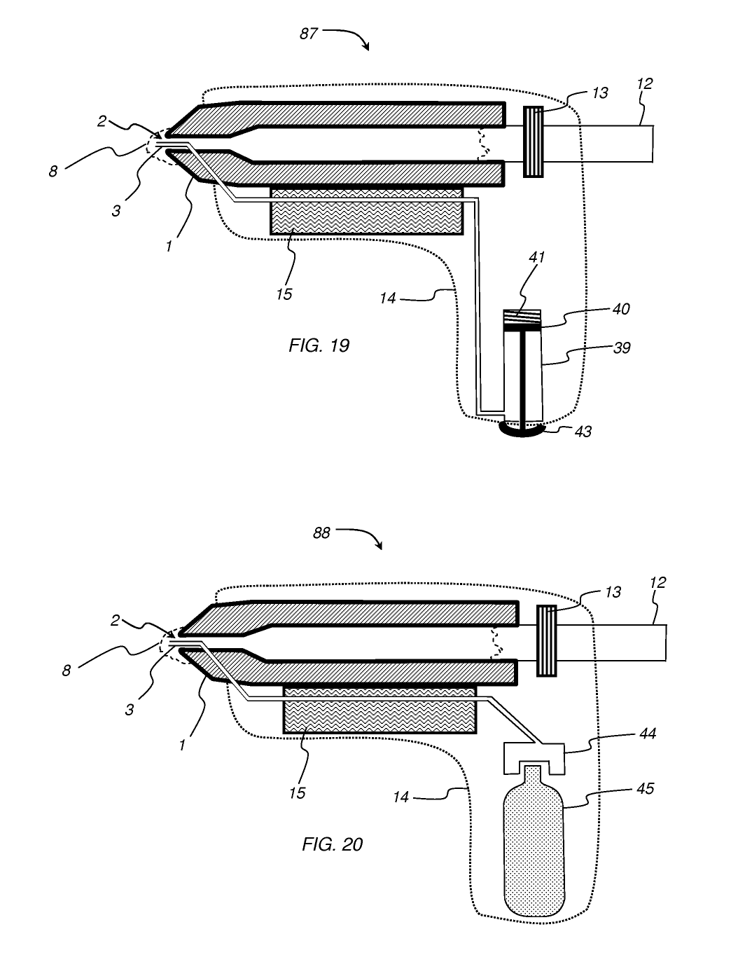

Turning to FIG. 17 now, a glue gun 86 can use a bulb 38. To provide gas flow out of the gas port 3, the bulb 38 is squeezed. In one embodiment, one or more one-way check valves (not shown) can be used to control the direction of air flow into and out of bulb 38. These one-way check valves can ensure that glue (for example) does not get introduced into the gas port 3. In yet another embodiment, as illustrated in FIG. 18, a glue gun 87 incorporates a spring activated piston to provide the gas to the gas port 3. In such a configuration, the gun 87 illustrates one technique for using a manual device to provide gas flow to the gas port 3. In some embodiments, the pulling of a ring 42 engages a plunger 40 against one or more springs 41. To apply the gas, a trigger mechanism (not shown) is activated to allow the compressed spring 41 to rapidly push the plunger 40 into the piston body 39, thus creating a blast of gas that exits through the gas port 3. As shown in FIG. 19, the glue gun 87 can also have a configuration where the plunger 40 is put in the active position against springs 41 by pressing a compression end 43 into the body of 87 as the glue gun 87 is pressed against a surface, for example.

As shown in FIG. 20, in one embodiment a cylinder of compressed gas 45 resides in the handle of the applicator and provides the gas to port 3. 45 is connected through a pressure regulator and or valve assembly, represented by 44. The regulator, if needed, may be a separate piece from the valve.

It should be understood by those of ordinary skill in the relevant technology, that electrical pumps, gas cylinders, combustion gases, steam, and mechanical devices that operate by a user's energy can also facilitate the provision of gas to the gas port 3. Such devices can include, but are not limited to, hand pumps and foot pumps and their intermediate gas storage devices such as rubber bladders and air chambers.

The embodiments described herein are examples provided to meet the descriptive requirements of the law and to provide examples. The embodiments described herein are examples provided in order to explain and to facilitate the full comprehension and enablement of all that is disclosed herein and the description of these examples is not intended to be limiting in any manner. Therefore, the invention is intended to be defined by the claims that follow and not by any of the examples or terms used herein. Additionally, terms utilized herein have been used in their broad respective senses unless otherwise stated. Therefore, terms should not be read as being used in any restrictive sense or as being redefined unless expressly stated as such.

What is claimed is:

1. An applicator for applying a substance, the applicator comprising:
a) a nozzle adapted to deliver the substance; and a gas port configured to be enveloped by the substance and to deliver a gas flow to disrupt a flow of the substance.

2. The applicator of claim 1, wherein the gas port is coaxial with the nozzle.

3. The applicator of claim 1, wherein the gas port is adjacent to the nozzle and configured to deliver the gas flow in a direction that is coaxial with the flow of the substance from the nozzle.

4. The applicator of claim 1, wherein the gas port has a gas port outer surface that is smaller than an inner nozzle surface such that a space between the gas port outer surface and the inner nozzle surface is the flow path for the substance.

5. The applicator of claim 1, wherein the gas port is configured to deliver a gas flow that breaks the flow of the substance.

6. The applicator of claim 1, wherein the gas port comprises tubing located adjacent and externally to the nozzle, and wherein the gas port terminates in front of the nozzle such that the substance envelopes an end of the tubing.

7. The applicator of claim 1, wherein the gas port comprises tubing located at least partly within the nozzle and exits the nozzle in a zone between an end of the nozzle and the work surface or receptacle such that the substance envelopes an end of the tubing.

8. The applicator of claim 1, wherein the nozzle is configured to supply a hot melt adhesive.

9. The applicator of claim 1, wherein the gas port is in a fixed position that extends between 0.5 to 30 millimeters beyond an end of the nozzle.

10. The applicator of claim 1, wherein the gas port is configured to deliver a gas flow comprising a gas selected from the group consisting of: air, nitrogen, carbon dioxide, halogenated compounds, steam, hydrocarbons, and combustion products.

11. The applicator of claim 1, wherein the gas port is configured to have a gas pressure of at least 5-psi and a gas flow having duration of between 0.01 and 3.0 seconds.

12. The applicator of claim 1, wherein the applicator comprises a hot melt adhesive gun.

13. A method of facilitating the disruption of strings formed by the application of a substance, the method comprising:
a) providing a nozzle for delivering the substance;
b) providing a gas port configured to deliver a gas flow;
c) positioning the gas port relative to the nozzle such that the substance flowing from the nozzle envelopes at least a portion of the gas port, and such that the gas flow from the gas port can disrupt the flow of the substance.

14. The method of claim 13, wherein positioning the gas port comprises positioning the gas port at least partially inside the nozzle and coaxial with the nozzle.

15. The method of claim 13, wherein positioning the gas port comprises positioning the gas port at least partly externally and adjacent to the nozzle, wherein an end of the gas port is configured to deliver the gas flow in a direction that is coaxial with the direction of flow of the substance.

16. The method of according to claim 13, wherein providing a nozzle comprises providing a hand-held glue gun.

17. A detachable nozzle for a substance applicator, wherein the substance application and the detachable nozzle are adapted to receive a gas port tubing.

18. The nozzle of claim 17, wherein the nozzle has multiple substance outlet ports and corresponding multiple gas ports for disrupting the flow of the substance.

19. The nozzle of claim 17, wherein the gas port comprises tubing located at least partly within the nozzle and exits the nozzle in a zone between an end of the nozzle and the work surface or receptacle such that the substance envelopes an end of the tubing.

20. The nozzle of claim 17, wherein the gas port is in a fixed position that extends between 0.5 to 30 millimeters beyond an end of the nozzle.
